(19) United States
(12) Patent Application Publication
(10) Pub. No.: US 2004/0203526 A1
(43) Pub. Date: Oct. 14, 2004

(54) Wireless communication device with automatically deploying and retracting antenna

(76) Inventors: Ricardo Romeu, Boca Raton, FL (US); Gregory Paul Cheraso, West Palm Beach, FL (US)

Correspondence Address: MOTOROLA INC, 600 NORTH US HIGHWAY 45, ROOM AS437, LIBERTYVILLE, IL, 60048-5343, US

(21) Appl. No.: 10/335,634

(22) Filed: Dec. 31, 2002

(51) Int. Cl. H04B 1/38

(52) U.S. Cl. 455/90.3; 455/575.1

(57) ABSTRACT

A physically re-configurable wireless communication device (e.g., 100) includes an antenna (e.g., 111) that automatically deploys and retracts responsive to a change in the device's physical configuration. The wireless device includes two support housing members (e.g., 101, 102) and an antenna housing member (e.g., 103). The support members are mechanically coupled to one another such that they are movable relative to one another to place the wireless device is into either a closed position or an open position. The antenna member is mechanically coupled to one of the support members such that movement of either support member relative to the other to place the wireless device into the open position automatically configures the antenna member into a deployed operational position. Movement of either support member relative to the other to place the wireless device into the closed position automatically reconfigures the antenna member into a less efficient, retracted operational position.

### CROSS REFERENCE TO RELATED APPLICATIONS

The present application is related to and hereby incorporates by reference, U.S. patent application Motorola Docket No. PT03710U, entitled “Hand Held Communication Device With Decoupled Antenna,” filed on an even date herewith, and assigned to the assignee of the present application.

### FIELD OF THE INVENTION

The present invention relates generally to wireless communication devices and, in particular, to a physically re-configurable wireless communication device having an automatically deploying and retracting antenna.

### BACKGROUND OF THE INVENTION

Cellular phones, pagers, personal digital assistants (PDAs) and other wireless communication devices come in a variety of mechanical configurations. Some devices are relatively straight having their microphones and audio transducers (e.g., ear speakers) available for use at all times. Such devices are often referred to as “candy bar” devices. Other devices are configurable into multiple positions or configurations depending on the current mode of the device. For example, devices, such as the i90c, i95cl, V60, V66, V70, and Timeport P8097 phones that are commercially available from Motorola, Inc. of Schaumburg, Ill., U.S.A. (hereinafter “Motorola”), are configurable into two positions, a closed or compact position in which the device's microphone or audio transducer is adjacent another portion of the device to place the device in a standby mode (e.g., capable of receiving phone calls, but not placing them) and an open or extended position in which the device's microphone and audio transducer are adequately separated to place the device in an in-use mode (e.g., capable of receiving and placing phone calls).

Communication devices such as Motorola's i90c, i95cl, V60, V66, and Timeport P8097 phones are configurable into their open and closed positions by rotating one part of the phone containing the audio transducer (e.g., flip member) about a hinge relative to another part of the phone containing the microphone (e.g., base member), wherein the rotation of the flip member occurs in a plane perpendicular to the plane containing the base member. Such phones or devices are typically referred to as “clamshell” or “flip” devices. Communication devices such as Motorola's V70 phone are configurable into their open and closed positions by similarly rotating the part of the phone containing the audio transducer relative to another part of the phone containing the microphone; however, in these devices, the rotation occurs in a plane substantially parallel to the plane containing the part of the device housing the microphone. Devices such as Motorola's V70 phone may be referred to as “twist”, “swivel”, or “rotational” devices. Re-configurable devices are used primarily to minimize the size of the device while the device is in its standby mode (closed position), while providing a more conventional phone or device feel to the user when the device is in its in-use mode (open position).

All wireless devices utilize antennas to emit and receive wireless communication signals. Such antennas are typically either external or internal. External antennas are typically fabricated in two ways. First, an external antenna may be fabricated as a fixed stub extending from a top end of the device. Alternatively, an external antenna may be fabricated as a combination of a bored or hollowed stub extending from the top end of the device and a flexible, plastic-encapsulated, telescopic antenna that can be manually extended from or retracted into the bored stub. Internal antennas are typically fabricated by disposing the antenna on an inside surface of the wireless device housing.

The effectiveness of antennas is determined by each antenna's radiation pattern. Perturbations in the antenna's radiation pattern due to placing objects, such as a user's head or hand, on or near the antenna reduces the effectiveness of the antenna and the perceived quality of service of the wireless communication device. Consequently, the most desirable antenna performance occurs when any possibly interfering objects are not in the near field of the antenna (i.e., are not located less than one-quarter wavelength away from the antenna).

External antennas have the benefit of being very visible; consequently, users are less likely to place any object on or near the antenna during use. On the other hand, external antennas are not very visually appealing and, due to the stub extending from them, can feel awkward when placed in the pants pocket of the user. Internal antennas facilitate a more visually appealing device, but users are more likely to place their hand over them during use because they are not typically visible.

Therefore, a need exists for a wireless communication device that includes an antenna that provides the benefits of both internal and external antennas without containing their drawbacks.

### BRIEF DESCRIPTION OF THE DRAWINGS

FIG. 1 is a perspective view of a wireless communication device in a closed position in accordance with a preferred embodiment of the present invention.

FIG. 2 is a perspective view of the wireless communication device of FIG. 1 in an open position.

FIG. 3 is a left side isometric view of the wireless communication device of FIG. 1 as the device is being reconfigured from the open position to the closed position.

FIG. 4 is a left side isometric view of a wireless communication device in an open position in accordance with an alternative embodiment of the present invention.

FIG. 5 is a left side isometric view of a wireless communication device being reconfigured from the closed position to the open position in accordance with another embodiment of the present invention.

FIG. 6 is a left side isometric view of a wireless communication device in an open position in accordance with yet another embodiment of the present invention.

FIG. 7 is a left side isometric view of the wireless communication device of FIG. 6 in a closed position.

FIG. 8 is a side view of an axial brush contact interconnect mechanism in accordance with a preferred embodiment of the present invention.

FIG. 9 is a cross-sectional view of the axial brush contact interconnect mechanism of FIG. 8.

FIG. 10 is a perspective view of a wireless communication device in a closed position in accordance with yet another embodiment of the present invention.

FIG. 11 is a perspective view of the wireless communication device of FIG. 10 in an open position.

### DETAILED DESCRIPTION OF A PREFERRED EMBODIMENT

Generally, the present invention encompasses a physically re-configurable wireless communication device that automatically deploys and retracts its antenna responsive to a change in the device's physical configuration. The wireless device includes two support housing members and an antenna housing member. The two support housing members each include one or more electrical components, such as a microphone or an audio transducer, and are mechanically coupled to one another such that they are movable relative to one another to place the wireless device into either a closed position or an open position. The antenna housing member is mechanically coupled to one of the two support housing members such that movement of either support housing member relative to the other to place the wireless device into the open position automatically configures or deploys the antenna housing member into a desired operational position for an antenna contained therein. Analogously, movement of either support housing member relative to the other to place the wireless device back into the closed position automatically configures or retracts the antenna housing member into a less efficient operational position for the antenna. By controlling antenna deployment and retraction in this manner, the present invention provides an antenna that has the visually appealing look of an internal antenna when the wireless device is in its closed position, while being automatically repositioned for desired performance when the wireless device is configured into its open position.

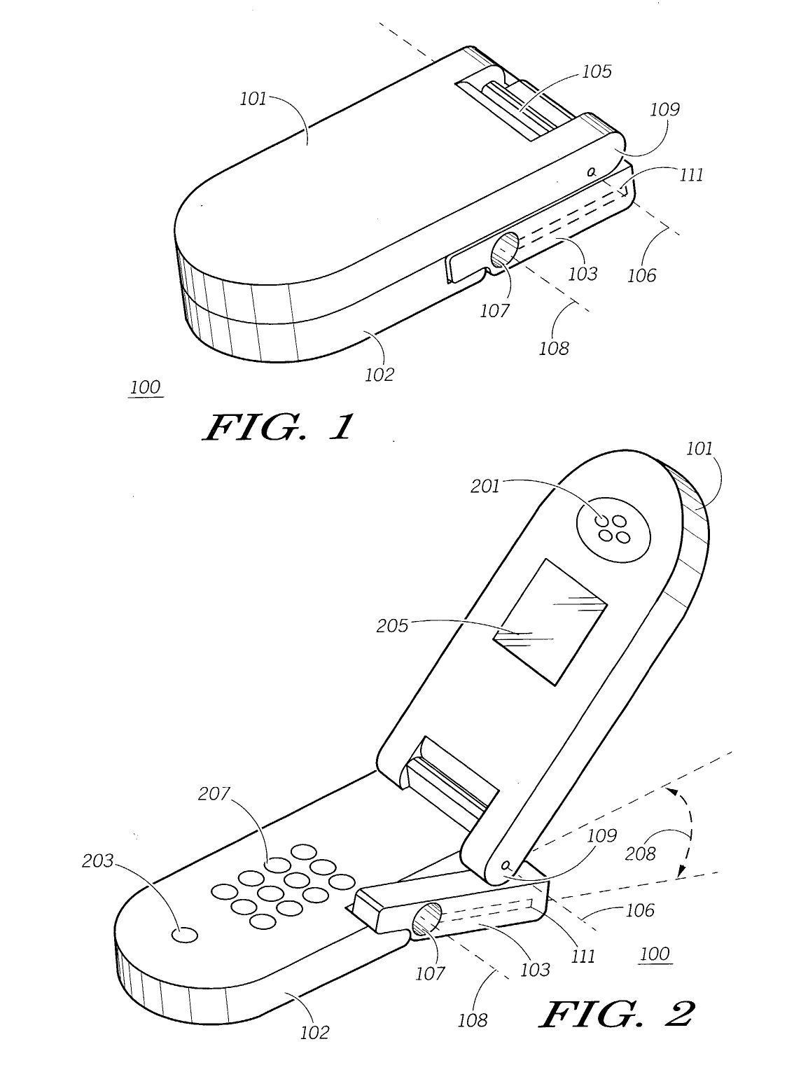

The present invention can be more fully understood with reference to FIGS. 1-11, in which like reference numerals designate like items. FIGS. 1 and 2 are perspective views of a wireless communication device 100 in closed and open positions, respectively, in accordance with a preferred flip or clamshell embodiment of the present invention. The wireless communication device 100 may comprise a cellular telephone, a personal digital assistant, a pager, a two way radio or any other type of device capable of providing two-way communications. The discussion contained herein will focus on application of the present invention in a cellular telephone.

The wireless communication device 100 includes a flip housing member 101, a base housing member 102, and an antenna housing member 103. Each housing member 101-103 is preferably constructed of metal or injection molded plastic and, as described in more detail below, encloses and supports various conventional electrical circuit components. For example, the flip housing member 101 may include, inter alia, an acoustic transducer 201 (e.g., a low power speaker) and a display 205; whereas, the base housing member 102 may include, inter alia, a radio frequency (RF) transceiver (not shown), an acoustic receptor 203 (e.g., a microphone), a keypad 207 or other user interface, and a battery (not shown). The antenna housing member 103 preferably retains the antenna element(s) 111, but may alternatively include an RF transmitter, a power amplifier or other radiating circuitry as discussed in more detail in co-pending U.S. patent application Ser. No. ______, entitled “Hand Held Communication Device With Decoupled Antenna”, which application was filed on an even date herewith and is assigned to the assignee of the present invention. Interconnection of the electrical circuit components in the flip and base housing members 101, 102 is well known; thus no further discussion will be presented. Interconnection of the antenna 111 in the antenna housing member 103 to electrical components in the base housing member 102 (or similarly to electrical components in the flip housing member 101 in the event that the antenna housing member 103 was mechanically coupled to the flip housing member 101 instead of the base housing member 102) is described in an exemplary manner below with respect to FIGS. 8 and 9.

As used herein, the term “closed configuration” or “closed position” refers to a mechanical configuration in which the wireless device 100 is in its most compact state. In the flip or clamshell device embodiment depicted in FIGS. 1 and 2, the closed position is the configuration in which the flip housing member 101 and the base housing member 102 are positioned substantially adjacent to (e.g., near) each other, such that the acoustic transducer 201 in the flip housing member 101 is positioned substantially adjacent to the acoustic receptor 203 or some other part of the base housing member 102. The term “open configuration” or “open position” as used herein refers to a mechanical configuration in which the wireless device 100 is in a less compact state to facilitate a more conventional phone style use of the wireless device 100. In the flip or clamshell device embodiment depicted in FIGS. 1 and 2, the open position is the configuration in which the flip housing member 101 and the base housing member 102 are no longer positioned adjacent to each other.

In the flip embodiment depicted in FIGS. 1 and 2, the flip housing member 101 is mechanically coupled to the base housing member 102 preferably through use of a hinge 105. Hinge 105 permits either the flip member 101 or the base member 102 to rotate about a pivot axis 106 to configure or reconfigure the wireless device 100 into the closed position (depicted in FIG. 1) or the open position (depicted in FIG. 2). The antenna housing member 103 is mechanically coupled to the base member 102 preferably through use of another hinge 107. Hinge 107 permits the antenna housing member 103 to rotate about another pivot axis 108 to be configured or reconfigured into either a deployed operational position (illustrated in FIG. 2) or a retracted operational position (illustrated in FIG. 1) for the antenna 111. The antenna 111 operates more efficiently when the antenna housing member 103 is in the deployed position than when the antenna housing member 103 is in the retracted position because, in the deployed position, the antenna 111 is, inter alia, positioned further from the device user.

To re-configure the wireless device 100 from the closed position of FIG. 1 to the open position of FIG. 2, the user rotates either the flip member 101 or the base member 102 about pivot axis 106. During the rotation, a lobe 109 or arm of the flip member 101 engages and exerts a force upon a part of the antenna housing member 103 causing the antenna housing member 103 to automatically rotate about axis 108 into its deployed operational position. The lobe 109 is preferably eccentrically shaped to facilitate a smooth rotation of the flip member 101 while enabling engagement of the antenna housing member 103.

In a preferred embodiment, hinge 107 includes a cam or a spring that snaps the antenna housing 103 into its fully deployed position once lobe 109 forces the engaged portion of the antenna housing member 103 past a predetermined displacement or rotational angle 208 relative to the location of the antenna housing member 103 when the antenna housing member 103 is in its fully retracted operational position. For example, in the preferred embodiment, once lobe 109 forces the antenna housing member 103 to a rotational angle 208 of greater than about ten (10) degrees, the cam or spring forming part of hinge 107 snaps the antenna housing member 103 into its fully deployed position in which the rotational angle 208 is approximately forty (40) degrees. One of ordinary skill in the art will readily appreciate that the rotational angle 208 or displacement at which the hinge cam or spring snaps the antenna housing member 103 into its fully deployed position can vary based on a variety of factors, such as the length of the lobe 109, the length of the antenna housing member 103, and the desired preload torque on the antenna housing member 103 in either the retracted or deployed position. Similarly, one of ordinary skill in the art will also appreciate that the rotational angle 208 of the antenna housing member 103 when the antenna housing member 103 is fully deployed may vary to almost any angle depending on the particular design of the antenna 111 enclosed within the antenna housing member 103.

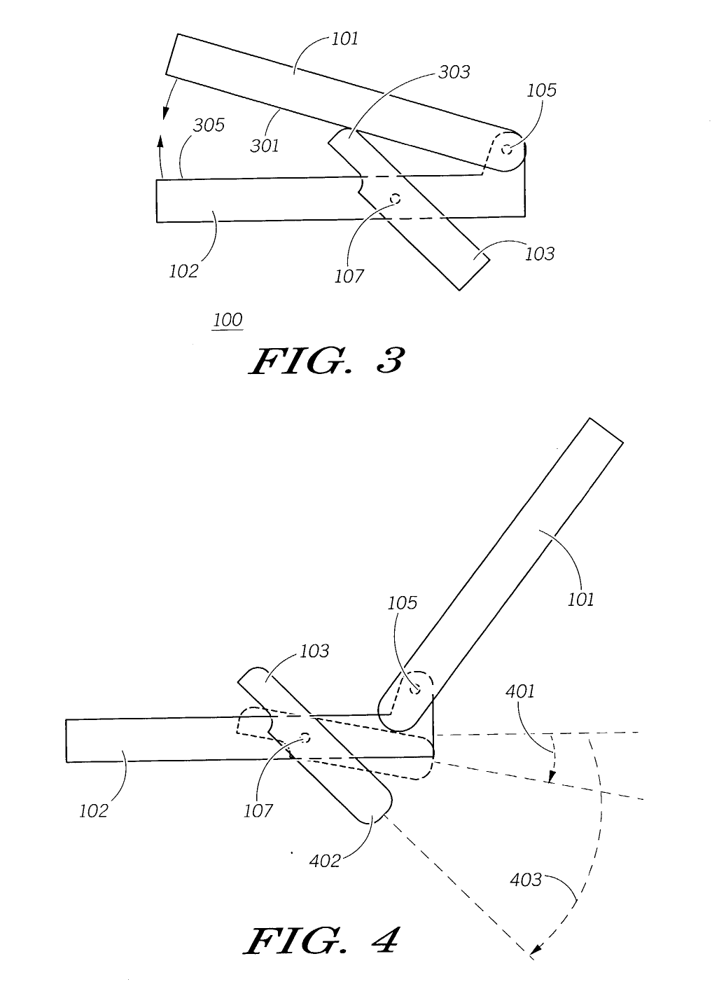

After the user has completed using the wireless device 100 for its intended purpose, the user simply closes the flip member 101 (or the base member 102, as applicable) to automatically retract the deployed antenna housing member 103. Retraction of the antenna housing member 103 is depicted in FIG. 3. As the flip member 101 is rotated about axis 106 back into the closed position, an inside surface 301 of the flip member 101 engages an exposed end 303 of the antenna housing member 103 extending above an inside surface 305 of the base member 102 to rotate the antenna housing member 103 about axis 108 and back into the fully retracted position. That is, as the wireless device 100 is closed, the flip member 101 exerts a force on the exposed end 303 of the antenna housing member 103 to automatically configure the antenna housing member 103 into its retracted position.

In an alternative embodiment, the hinge 107 mechanically coupling the antenna housing member 103 to the base member 102 may facilitate a continuous rotational angle 401 responsive to rotation of the flip member 101 relative to the base member 102. Such an embodiment is illustrated in FIG. 4. In this embodiment, during opening of the flip member 101 (or base member 102 as the case may be), the lobe 109 of the flip member 103 engages and exerts a force on a part of the antenna housing member 103. The force on the antenna housing member 103 causes the antenna housing member 103 to automatically rotate about pivot axis 108 as discussed above. However, in contrast to the embodiment described above with respect to FIGS. 1-3, the antenna housing member 103 in this embodiment does not automatically snap into a fully deployed position once a predetermined rotational angle or displacement is reached. Rather, in this embodiment, the antenna housing member 103 remains engaged with the lobe 109 of the flip member 101 to slowly deploy to a minimum rotational angle 401 (as illustrated by the dashed antenna housing member in FIG. 4) as the flip member 101 is rotated. Alternatively, the hinge 107 coupling the base member 102 to the antenna housing member 103 may further include a cam or spring such that when force is manually exerted on the deployed end 402 of the antenna housing member 103 to direct the antenna housing member 103 further away from the flip member 101, the antenna housing member 103 snaps into an auxiliary operational position, such as the fully deployed position at a maximum desired rotational angle 403. One of ordinary skill in the art will readily appreciate that the cam or spring may be designed to permit rotation of the antenna housing member 103 into multiple auxiliary operational positions culminating in an operational position corresponding to the fully deployed position.

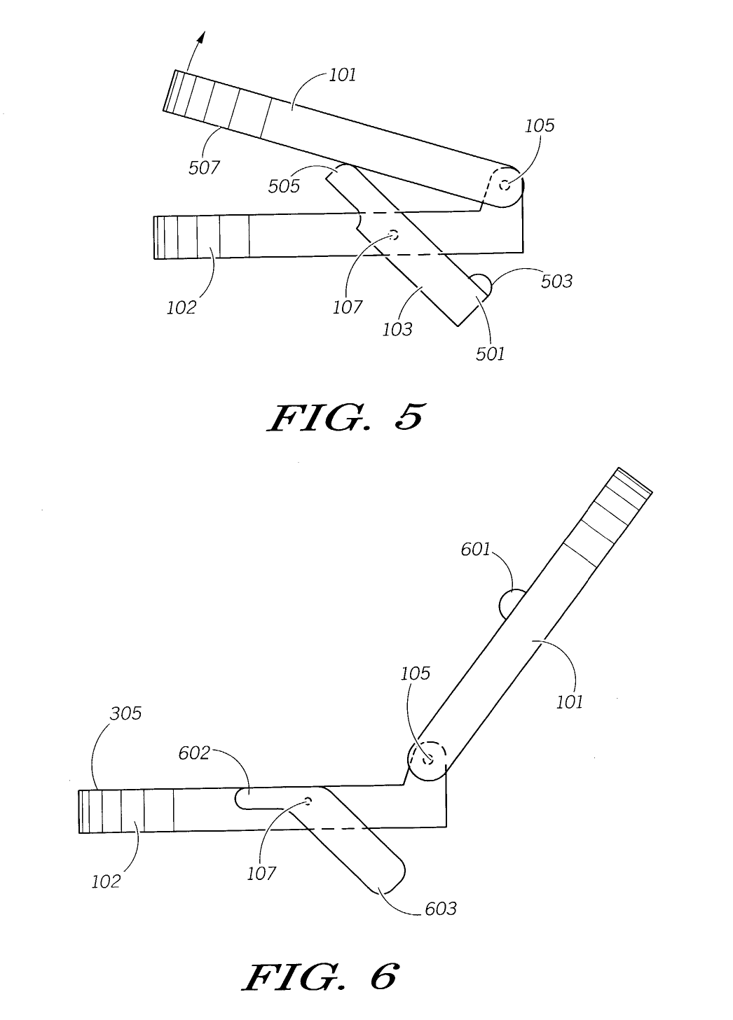

In yet another embodiment, instead of or in addition to hinge 107 including a cam or spring, hinge 105 may include a cam or a spring such that when force is manually exerted on an end portion 501 of the antenna housing member 103, the flip member 101 is automatically rotated into the open configuration. Such an alternative embodiment is illustrated in FIG. 5. In this case, the antenna housing member 103 preferably includes a press area 503, such as a nub, a tab, a recess, or a textured area, to facilitate an exertion of force on the end 501 of the antenna housing member 103 by the user. Exertion of force on the press area 503 directed away from the flip member 101 causes the opposing end 505 of the antenna housing member 103 to rotate about pivot axis 108 and exert an opposing force on an inside surface 507 of the flip member 101, thereby rotating the flip member 101 about pivot axis 106. Once the flip member 101 rotates or displaces a predetermined amount or is sufficient to overcome a latching force present between the flip member 101 and the base member 102, the flip member 101 automatically snaps into the open position in a manner similar to that described above with respect to the automatic deployment of the antenna housing member 103 in response to opening of the flip member 101.

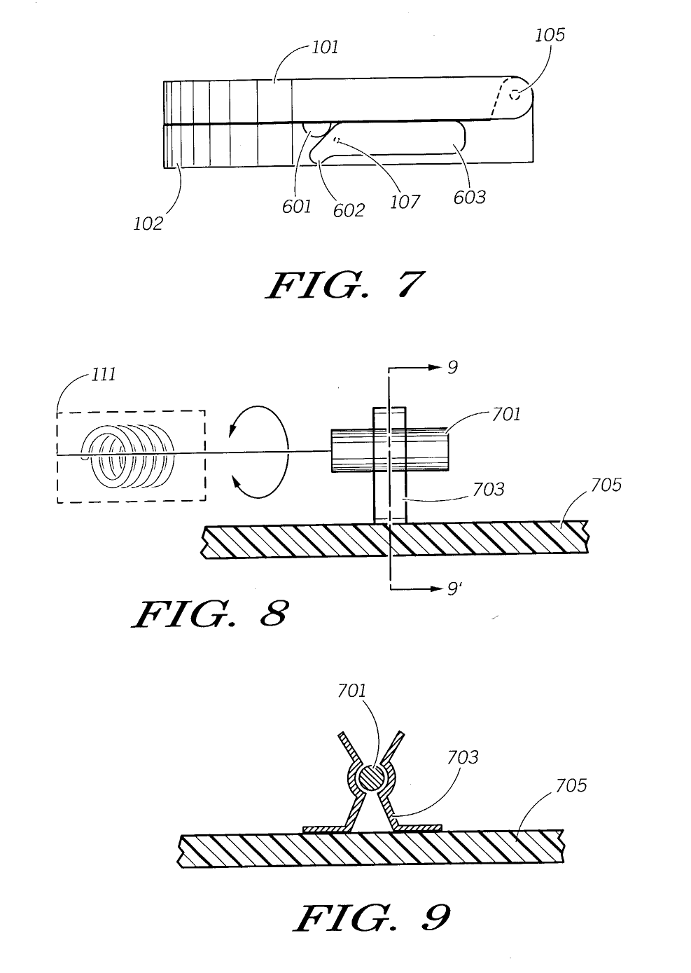

In yet another embodiment, instead of having an exposed end 303 that extends above an inside surface of the base member 102 when the antenna housing member 103 is fully deployed as shown in FIG. 3, the antenna housing member 103 may be constructed to be substantially flush or coplanar with the inside surface 305 of the base member 102 when the antenna housing member 103 is so deployed, as illustrated in FIGS. 6 and 7. In this embodiment, the flip member 101 preferably includes a nub or other protrusion 601 constructed to engage and exert a force upon the flush end 602 of the antenna housing member 603 when the flip member 101 and/or the base member 102 are rotated into the closed position. The force exerted by the protrusion 601 causes the antenna housing member 603 to rotate into the retracted position.

In the flip or clam shell embodiments described above with respect to FIGS. 1-7, the antenna 111 is preferably electrically connected to the RF circuitry housed in the base member 102 through an interconnect mechanism. The interconnect mechanism may comprise a miniature coaxial cable, a radial brush contact, an axial brush contact or any other suitable connection that provides electrical conductivity while permitting the required movement of the antenna housing member 103, 603 relative to the base member 102 (or the flip member 102, as the case may be). An embodiment in which the interconnection mechanism is an axial brush contact is illustrated in FIGS. 8 and 9. As shown in FIGS. 8 and 9, when the interconnect mechanism is an axial brush contact 703, the contact 703 is soldered or otherwise attached to a printed circuit (PC) board 705 that is secured or fastened within the base member 102. In this case, the antenna 111 includes a pin 701 that press fits into the brush contact 703 to provide the electrical connectivity between the antenna 111 and the PC board circuitry. When the antenna housing member 103, 603 is deployed and retracted, the antenna pin 701 rotates within the contact 703 while maintaining electrical connectivity with the contact 703. Thus, in this embodiment, the contact 703 also functions as a hinge 107 that facilitates rotational movement of the antenna housing member 103, 603 relative to the base member 102, and the antenna pin 701 also functions as a hinge pin.

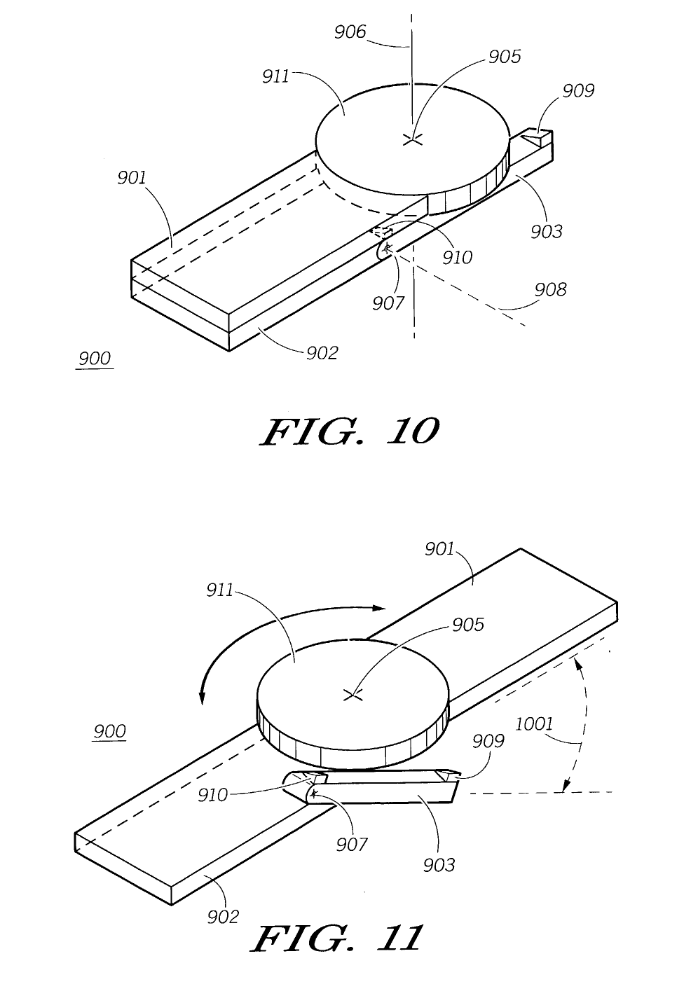

FIGS. 10 and 11 are perspective views of a wireless communication device 900 in closed and open positions, respectively, in accordance with an alternative swivel embodiment of the present invention. In this embodiment, the wireless communication device 900 includes a swivel housing member 901, a base housing member 902, and an antenna housing member 903. Each housing member 901-903 is preferably constructed of metal or injection molded plastic, and encloses and supports various conventional electrical circuit components. The antenna housing member 903 preferably includes a nub 909 at a distal end thereof to facilitate deployment of the antenna housing member 903 as described in more detail below. In addition, the opposite end of the antenna housing member 903 is preferably ramped, arced or angled, or alternatively includes a nub 910 similar to nub 909, to facilitate retraction of the antenna housing member 903 as described in more detail below.

The swivel housing member 901 is mechanically coupled to the base housing member 902 through use of a hinge 905. Hinge 905 permits either the swivel member 901 or the base member 902 to rotate about a pivot axis 906 to configure or reconfigure the wireless device 900 into the closed position (depicted in FIG. 10) or the open position (depicted in FIG. 11). The antenna housing member 903 is mechanically coupled to the base member 902 through use of another hinge 907. Hinge 907 permits the antenna housing member 903 to rotate about another pivot axis 908 to be configured or reconfigured into either a deployed operational position (illustrated in FIG. 11) or a retracted operational position (illustrated in FIG. 10) for an antenna (not shown) housed within the antenna housing member 903. The antenna operates more efficiently when the antenna housing member 903 is in the deployed position than when the antenna housing member 903 is in the retracted position because, in the deployed position, the antenna is, inter alia, positioned further from the device user.

To re-configure the wireless device 900 from the closed position of FIG. 10 to the open position of FIG. 1, the user rotates either the swivel member 901 or the base member 902 about pivot axis 906. During the rotation, a part of the swivel member 901 engages and exerts a force upon nub 909 of the antenna housing member 903 causing the antenna housing member 903 to automatically rotate about axis 908 into its deployed operational position. Nub 909 is preferably constructed in the shape of a ramp or arc to enable the swivel member 901 to easily engage the nub 909 and travel up the nub 909 forcing the antenna housing member 903 away from the base member 902 and the swivel member 901.

In a preferred embodiment, hinge 907 includes a cam or a spring that snaps the antenna housing 903 into its fully deployed position once the swivel member 901 forces the antenna housing member 903 past a predetermined displacement or rotational angle 1001 relative to the location of the antenna housing member 903 when the antenna housing member 903 is in its fully retracted operational position. For example, once the swivel member 901 forces the antenna housing member 903 to a rotational angle 1001 of greater than about ten (10) degrees, the cam or spring forming part of hinge 907 snaps the antenna housing member 903 into its fully deployed position in which the rotational angle 1001 is approximately forty (40) degrees. One of ordinary skill in the art will readily appreciate that the rotational angle 1001 or displacement at which the hinge cam or spring snaps the antenna housing member 903 into its fully deployed position can vary based on a variety of factors, such as the height of nub 909, the length of the antenna housing member 903, and the desired preload torque on the antenna housing member 903 in either the retracted or deployed position. Similarly, one of ordinary skill in the art will also appreciate that the rotational angle 1001 of the antenna housing member 903 when the antenna housing member 903 is fully deployed may vary to almost any angle depending on the particular design of the antenna (not shown) enclosed within the antenna housing member 903.

After the user has completed using the wireless device 900 for its intended purpose, the user simply closes the swivel member 901 (or the base member 902, as applicable) to automatically retract the deployed antenna housing member 903. As the swivel member 901 is rotated (e.g., counterclockwise) about axis 907 back into the closed position, the swivel member 901 engages and exerts a force upon the exposed or elevated end or nub 910 of the antenna housing member 903 causing rotation of the antenna housing member 903 about axis 908 and back into the fully retracted position. That is, as the device 900 is closed, the swivel member 901 engages the elevated end or nub 910 of the antenna housing member 903 and travels up the angled end or nub 910 forcing the antenna housing member 903 to automatically reconfigure into its retracted position. As mentioned above, the elevated end of the antenna housing member 903, or a nub 910 thereon, is preferably constructed in the shape of a ramp or arc to enable the swivel member 901 to easily engage the antenna housing member 903 forcing the antenna housing member 903 to rotate about axis 908 toward the swivel member 901 and into its retracted position.

In an alternative embodiment, the swivel member 901 may include an angled, ramped or arced nub (not shown), similar to nub 909, but inverted or otherwise appropriately configured, that extends from a central portion 911 of the swivel member 901 so as to engage and exert a force upon the elevated end of the antenna housing member 903 as the wireless device 900 is closed to automatically reconfigure the antenna housing member 903 into its retracted position. That is, as the device 900 is closed, the nub on the swivel member's central portion 911 engages the elevated end of the antenna housing member 903 causing the antenna housing member 903 to deflect into its retracted position (e.g., in conjunction with a spring or cam in hinge 907) as the antenna housing member 903 travels up the nub.

As described above, the present invention encompasses a wireless communication device that includes an automatically deploying and retracting antenna. Such a device has the appearance of providing an internal antenna, while providing the performance benefits of an external antenna. Thus, the present invention provides a wireless communication device having the benefits of both internal and external antennas, without exhibiting their drawbacks.

In the foregoing specification, the present invention has been described with reference to specific embodiments. However, one of ordinary skill in the art will appreciate that various modifications and changes may be made without departing from the spirit and scope of the present invention as set forth in the appended claims. For example, while the above embodiments are directed to automatic deployment and retraction of antennas in flip or swivel type wireless devices, and use of an antenna to automatically open a flip type device, one of ordinary skill in the art will readily recognize that the present invention may be employed in any wireless communication device that includes housing members that can be arranged into at least two mechanical configurations. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

What is claimed is:

1. A wireless communication device comprising:
a first housing member containing an acoustic transducer;
a second housing member mechanically coupled to the first housing member such that the first housing member and the second housing member are movable relative to one another, the second housing member containing an acoustic receptor; and
a third housing member mechanically coupled to one of the first housing member and the second housing member such that the third housing member is movable relative to the one of the first housing member and the second housing member, the third housing member containing an antenna;
wherein movement of the first housing member relative to the second housing member automatically configures the third housing member into an operational position for the antenna.

2. The wireless communication device of claim 1, further comprising:
a hinge mechanically coupling the first housing member to the second housing member, the hinge facilitating rotational movement of the first housing member relative to the second housing member.

3. The wireless communication device of claim 1, wherein a second movement of the first housing member relative to the second housing member automatically configures the antenna housing member into a second, less efficient operational position for the antenna.

4. The wireless communication device of claim 3, wherein the second movement of the first housing member relative to the second housing member places the wireless communication device into a closed position in which the first housing member is substantially adjacent the second housing member.

5. The wireless communication device of claim 1, wherein the movement of the first housing member relative to the second housing member places the wireless communication device into an open position in which the first housing member and the second housing member are not substantially adjacent.

6. The wireless communication device of claim 1, further comprising:
a hinge mechanically coupling the third housing member to the one of the first housing member and the second housing member thereby facilitating rotational movement of the third housing member relative to the one of the first housing member and the second housing member.

7. The wireless communication device of claim 6, wherein the first housing member includes a lobe that exerts a force on a part of the third housing member when the first housing member and the second housing member are moved relative to each other causing the third housing member to rotate into the operational position.

8. The wireless communication device of claim 1, further comprising:
an interconnect for electrically coupling an electrical circuit within the one of the first housing member and the second housing member to the antenna.

9. The wireless communication device of claim 8, wherein the interconnect is one of a coaxial cable, a radial brush contact, and an axial brush contact.

10. The wireless communication device of claim 8, wherein the interconnect further functions as a hinge to facilitate rotational movement of the third housing member relative to the one of the first housing member and the second housing member.

11. The wireless communication device of claim 1, further comprising means for rotating the third housing member into at least one auxiliary operational position in response to an external force exerted on a part of the third housing member.

12. A wireless communication device comprising:
a first housing member that includes a lobe and contains an acoustic transducer;
a second housing member rotatably coupled to the first housing member, the second housing member including an acoustic receptor; and
an antenna housing member rotatably coupled to the second housing member;
wherein the lobe exerts a force on a first part of the antenna housing member sufficient to rotate the antenna housing member into an operational position in response to a rotation of the first housing member relative to the second housing member that places the wireless communication device into an open position.

13. The wireless communication device of claim 12, wherein a part of the first housing member exerts a force on a second part of the antenna housing member sufficient to rotate the antenna housing member into a second, less efficient operational position in response to a rotation of the first housing member relative to the second housing member that places the wireless communication device into a closed position.

14. A wireless communication device comprising:
a first housing member;
a second housing member rotatably coupled to the first housing member, the second housing member being substantially adjacent the first housing member when the wireless communication device is in a closed position; and
an antenna housing member rotatably coupled to the second housing member;
wherein when at least one of the first housing member and the second housing member is rotated to place the wireless communication device into an open position, a part of the first housing member exerts a force on a part of the antenna housing member to cause the antenna housing member to rotate from a retracted position into a deployed position.

15. The wireless communication device of claim 14, wherein when one of the first housing member and the second housing member is rotated to place the wireless communication device back into the closed position, the first housing member exerts a force on a second part of the antenna housing member to cause the antenna housing member to rotate back into the retracted position.

16. A wireless communication device comprising:
a first housing member;
a second housing member mechanically coupled to the first housing member so as to facilitate movement of the first housing member relative to the second housing member; and
an antenna housing member mechanically coupled to the second housing member so as to facilitate movement of the antenna housing member relative to the second housing member;
wherein movement of the first housing member relative to the second housing member to place the wireless communication device into an open position exerts a force on a part of the antenna housing member to automatically configure the antenna housing member into a deployed position.

17. The wireless communication device of claim 16, wherein a second movement of the first housing member relative to the second housing member to place the wireless communication device into a closed position exerts a force on a second part of the antenna housing member to automatically configure the antenna housing member into a retracted position.
